(19) United States
(12) Patent Application Publication
(10) Pub. No.: US 2026/0225475 A1
(43) Pub. Date: Aug. 6, 2026

(54) BATTERY CHARGING SYSTEM FOR VEHICLE WITH ULTRA-FAST CHARGING

(71) Applicant: SUBARU CORPORATION, Tokyo (JP)

(72) Inventor: Andrew Retzlaff, Camden, NJ (US)

(21) Appl. No.: 19/042,168

(22) Filed: Jan. 31, 2025

(51) Int. Cl. B60L 53/10; B60L 53/62; B60L 58/16

(52) U.S. Cl. CPC B60L 53/11; B60L 53/62; B60L 58/16; B60L 2250/00

(57) ABSTRACT

A battery charging system for a vehicle, is configured to: (a) operate a charging of a battery in a plurality of charging modes including: a normal charging mode with a first charging time, an ultra-fast charging mode with a second charging time shorter than the first charging time by temporarily raising a temperature limit of the battery; and (b) provide to a user an information including the charging times and impacts thereof on a state of health (SOH) of the battery for the plurality of charging modes, to assist the user to select one of the charging modes based on the provided information.

### FIELD OF THE INVENTION

This disclosure relates to battery charging systems and vehicle having the same.

### BACKGROUND ART

As electric vehicles (EVs) continue to gain widespread adoption, the demand for shorter battery charging times has increased significantly. One of the key challenges in achieving faster charging lies in managing the temperature of the battery during the charging process. Under typical charging conditions, the charging current is restricted when the battery reaches a predefined thermal limit to prevent excessive degradation or safety risks.

Certain methods have been proposed to address this challenge, including technologies that temporarily raise the temperature limit of the battery to reduce charging time. For example, Patent Document 1 discloses a method for temporarily increasing the thermal threshold during charging to achieve faster charging. However, these approaches often lack mechanisms to assess or mitigate the long-term impact on battery health, making them less practical for regular use.

This conventional approach prioritizes battery longevity and safety, but it also significantly prolongs charging times. As a result, users often face inconvenience, especially during long trips or situations requiring rapid recharging. Furthermore, existing methods do not provide users with sufficient transparency regarding the real-time impact of different charging modes on the battery's State of Health (SOH). This lack of information complicates efforts to balance charging speed with battery durability, leaving room for innovative solutions that address these dual concerns effectively.

### PRIOR ART DOCUMENTS

### Patent Documents

[Patent Document 1] International Publication No. WO 2020/230514

### SUMMARY OF THE INVENTION

The present disclosure provides a battery charging system and a vehicle having the same designed to enhance charging efficiency, flexibility, and user decision-making while managing the impact on the state of health (SOH) of the battery. The system is configured to operate in a plurality of charging modes, including a normal charging mode with a first charging time and an ultra-fast charging mode with a second charging time shorter than the first charging time. The ultra-fast mode achieves this reduced charging time by temporarily adjusting the temperature limit of the battery under controlled conditions.

In one aspect, the disclosure describes a system configured to provide information to users, such as drivers, about the charging times and the impacts of each mode on the SOH of the battery. This information enables users to select a charging mode based on their specific needs, balancing charging speed and long-term battery performance.

In another aspect, the system includes functionality to acquire the charging mode selected by the user and automatically initiate the charging operation in the selected mode. This ensures seamless user interaction with the system and reduces operational complexity.

In some embodiments, the system includes mechanisms for identifying conditions under which specific charging modes should be avoided. For example, the system may evaluate ambient temperature or the compatibility of charging equipment and provide guidance to the user, such as suggestions to avoid unsuitable modes or the exclusion of such modes from available options.

The system may further monitor environmental conditions, such as whether the ambient temperature is below a predetermined threshold, and adjust the availability of the ultra-fast charging mode to optimize performance and safety.

In some implementations, the system evaluates the compatibility of the charging equipment. For instance, if the charging equipment does not support the ultra-fast charging mode, the system may automatically exclude this mode from the user's available options.

The information provided to the user may be delivered in a visualized or audible format, ensuring clarity and ease of access. This information may be presented via equipment installed in the vehicle or through a mobile device connected to the vehicle.

In another embodiment, the system may support additional charging modes, such as a second ultra-fast charging mode with a third charging time, which is shorter than the first charging time and distinct from the second charging time. This enhances the system's flexibility to accommodate diverse user requirements.

The system may also represent the impact of each charging mode on the SOH as a numerical value or point, providing users with an intuitive understanding of the trade-offs associated with each mode.

Furthermore, the system may be capable of acquiring the SOH of the battery over time and providing projections of the SOH versus the vehicle's expected service life. This feature enables users to monitor the long-term effects of their charging decisions and optimize the battery's performance.

The present disclosure also encompasses methods for implementing the described functionalities, systems integrated into vehicles, and non-transitory computer-readable media or program products containing instructions to perform the methods.

A computer-implemented method for charging a battery for a vehicle may comprise:
(a) executing instructions, by a processor, to provide a plurality of charging modes for operating a charging of a battery, the plurality of charging modes including:
(i) a normal charging mode with a first charging time, and
(ii) an ultra-fast charging mode with a second charging time shorter than the first charging time by temporarily raising a temperature limit of the battery; and
(b) executing instructions, by the processor, to provide to a user information including the charging times and impacts thereof on a state of health of the battery for the plurality of charging modes, wherein the information assists the user in selecting one of the charging modes based on the provided information.

In some embodiments, the computer configured to perform the functions described herein, including providing a plurality of charging modes and assisting the user in selecting one of the charging modes, may be implemented as part of a vehicle control Electrical Control Unit (ECU). Alternatively, the computer may be implemented as part of a battery management system (BMS) or any other computing unit installed within the vehicle. The functions described may be executed by a single computing device or distributed across multiple computing devices within the vehicle.

For example, in some embodiments, the vehicle control ECU may be responsible for processing SOH and state of charge (SOC) data and coordinating with the BMS to adjust charging parameters. In other embodiments, the BMS may directly manage the charging parameters, such as temporarily raising the temperature limit of the battery, while the vehicle control ECU or an infotainment system provides relevant information to the user. Additionally, certain functions, such as storing historical SOH and SOC data or processing user preferences, may be performed by a dedicated storage or computing unit within the vehicle.

The functions described herein may also involve collaborative operation between multiple computing units. For instance, the vehicle control ECU may receive input from the BMS regarding battery status and communicate with an infotainment system to provide charging recommendations to the user. Similarly, the BMS may directly manage hardware-level adjustments for charging, while higher-level decision-making, such as selecting an appropriate charging mode based on the user's input, may be handled by the vehicle control ECU.

The described functions are not limited to any particular hardware configuration or specific computing architecture. Instead, the system may employ any combination of processors, microcontrollers, or other computing devices to execute the described steps. These processors may include single-core or multi-core architectures, distributed systems, or even networked computing units within the vehicle. In some embodiments, certain functions may also be executed in part by cloud-based systems or external computing resources that communicate with the vehicle over a network.

The flexibility of this implementation allows the described system to adapt to various vehicle designs and architectures, ensuring compatibility with different hardware configurations and enabling efficient management of the vehicle's charging processes.

Additional aspects and advantages of the present disclosure will become readily apparent to those skilled in the art from the following detailed description of exemplary embodiments, which are provided by way of example and are not intended to limit the scope of the disclosure. It is to be understood that the present disclosure is capable of other embodiments and various modifications without departing from the scope and spirit of the disclosure. Accordingly, the drawings and descriptions herein are to be regarded as illustrative and not restrictive.

### BRIEF DESCRIPTION OF THE DRAWINGS

The following figures illustrate exemplary embodiments of the present disclosure. These embodiments are provided for illustrative purposes only and are not to be construed as limiting.

FIG. 1 is a schematic diagram illustrating charging-related components a vehicle according to an embodiment.

FIG. 2 is a functional block diagram illustrating the configuration of the battery charging system according to an embodiment

FIG. 3 is a block diagram illustrating a configuration of a computing device according to an embodiment.

FIG. 4 is a flowchart illustrating a method of charging a battery according to an embodiment.

FIG. 5 is a graph showing the estimated charging times for different charging modes according to an example.

FIG. 6 is a graph showing the historical and projected impact of different charging modes on battery health (SOH) according to an example.

FIG. 7 is a pop-up notification on vehicle's display according to an example.

FIG. 8 is a pop-up notification on vehicle's display according to an example.

FIG. 9 is a pop-up notification on vehicle's display according to an example.

FIG. 10 is a graph showing a summary of the charging results according to an example.

FIG. 11 is a chart of battery temperature and C-rate for a Normal Charging mode according to an example.

FIG. 12 is a chart of battery temperature and C-rate for an Ultra-Fast Charging mode according to an example.

FIG. 13 is a chart of battery temperature and C-rate for another Ultra-Fast Charging mode according to an example.

FIG. 14 is a graph showing SOH decreases for three vehicles with different charging habits.

### DETAILED DESCRIPTION OF THE INVENTION

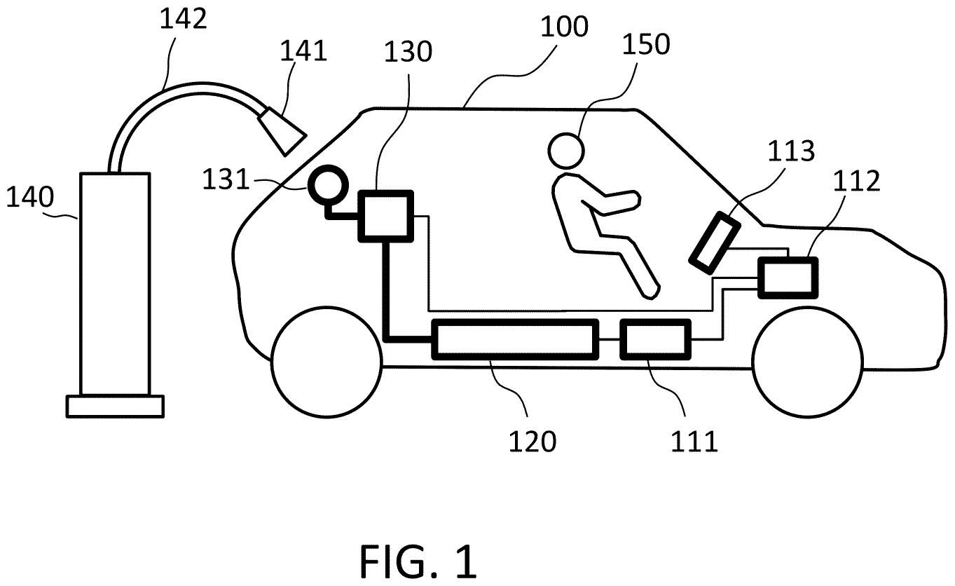

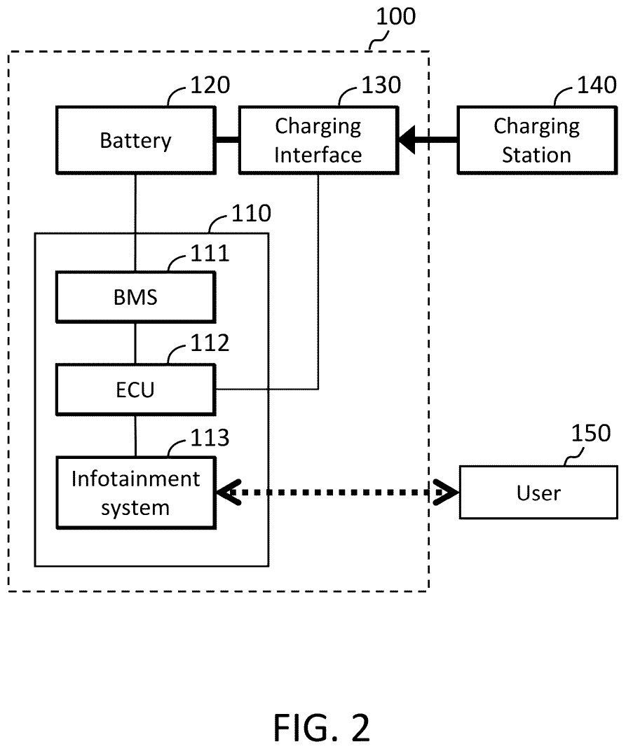

FIG. 1 is a schematic diagram illustrating the charging-related components of a vehicle 110 according to an embodiment. A user or driver 150 of the vehicle 100 is about to electrically charge the vehicle 100 at a charging station 140. FIG. 2 is a functional block diagram illustrating the configuration of the battery charging system 110 according to an embodiment.

The vehicle 100 includes a battery 120, a charging interface 130, a battery management system (BMS) 111, a vehicle control ECU 112, and an infotainment system 113.

FIG. 2 is a functional block diagram illustrating the configuration of the battery charging system 110 according to an embodiment. The battery charging system 110 integrates key components to manage and optimize the charging process:
A BMS 111 monitors and manages the battery 120's SOC, SOH, temperature, and other parameters to ensure safe and efficient charging and discharging.
A vehicle control ECU 112 oversees overall vehicle operation, including power distribution and driving modes, based on information from the BMS 111 and other vehicle systems.
An infotainment system 113 provides the user 150 with information about the battery's status and charging process, allowing the user to monitor the charging progress and make informed decisions.

The battery management system 111 is responsible for monitoring the SOH and SOC of the battery 120. The BMS 111 collects real-time data, including the capacity, internal resistance, and temperature of the battery 120, and optimizes the charging and discharging processes of the battery 120. The BMS 111 communicates with the vehicle control ECU 112 and the charging interface 130 to coordinate energy management.

The vehicle control ECU 112 oversees overall vehicle operation by receiving SOH and SOC data from the BMS 111. Based on the SOH and SOC data, the vehicle control ECU 112 adjusts power distribution, driving modes, and other parameters to enhance performance and ensure safe operation of the vehicle 100.

The infotainment system 113 provides SOH and SOC information to the user 150. The infotainment system 113 displays the SOH and SOC information on a dashboard screen or delivers the SOH and SOC information audibly. The infotainment system 113 allows the user 150 to monitor the condition of the battery 120 and make decisions regarding vehicle operation or charging.

The charging interface 130 includes a charging port 131 on the vehicle 100 and the charging station 140 includes a charging connector 141. The charging port 131 and charging connector 141 are configured in accordance with a standardized charging protocol (e.g., CHAdeMO, CCS, Type 1/2, GB/T) that defines their physical and electrical specifications. This standardized configuration ensures compatibility and interoperability between various charging stations and electric vehicles, facilitating the transfer of electrical power from the charging station 140 to the battery 120 of the vehicle 100.

The charging interface 130 also enables communication between the charging station 140 and the vehicle 100. This communication allows the exchange of information such as charging status, power requirements, safety protocols, and authentication and authorization information. This bidirectional communication enables the charging station 140 and the vehicle 100 to coordinate the charging process, optimize charging parameters, and ensure safety.

The user 150 refers to any individual interacting with the vehicle 100, including the driver and others who select charging modes or monitor the state of health and state of charge information of the battery 120. The user may be the driver of the vehicle. The user may be another passenger of the vehicle. The user may not necessarily be the driver or a passenger, but may be an individual who needs to interface with the vehicle.

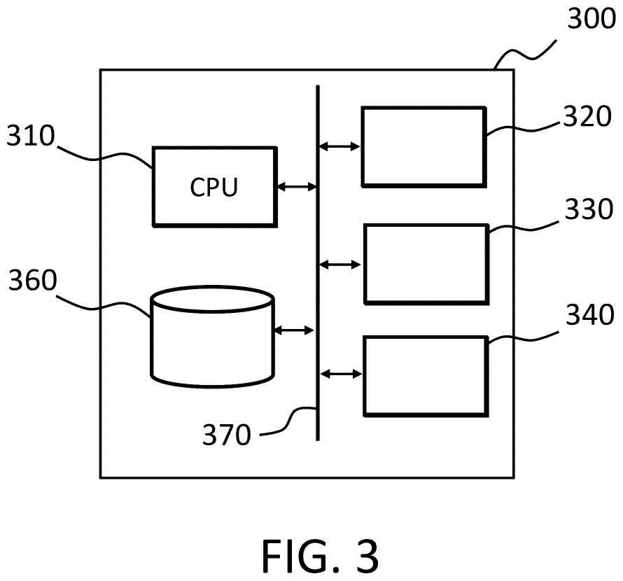

FIG. 3 is a block diagram illustrating a configuration of a computing device 300 according to an embodiment. The computing device 300, in this example a vehicle control ECU, constitutes a portion of the battery charging system 110 illustrated in FIG. 2. The vehicle control ECU 300 includes a processor 310, a communication unit 320, a memory 330, and a storage 340, all interconnected via a bus 370. The vehicle control ECU 300 can communicate with a storage 360 to store and retrieve SOH and SOC information.

The processor 310 may include an arithmetic logic unit, a microprocessor, a general-purpose controller, or multiple processors for parallel computing. The processor 310 serves as the central computing component of the vehicle control ECU 300 and processes SOH and SOC data received from the BMS 111. Although FIG. 3 shows a single processor 310, some embodiments may include multiple processors.

The communication unit 320 manages data communication with the storage 360 and other in-vehicle systems, such as the BMS 111 and the infotainment system 113. The communication unit 320 is configured to use standard vehicle communication protocols such as CAN (Controller Area Network) communication or Ethernet communication.

The memory 330 is a volatile memory for temporarily storing programs and data used by the processor 310 during operation. The memory 330 may include, for example, dynamic random-access memory (DRAM) devices or static random-access memory (SRAM) devices.

The storage 340 is a non-volatile storage medium for storing the operating system, application software, and calibration data that provide the core functionality of the vehicle control ECU 300. The storage 340 may include, for example, flash memory or solid-state drives (SSDs).

The storage 360 is a non-transitory storage medium for storing persistent data related to the operation of the vehicle control ECU 300, including SOH and SOC information and related data acquired from the BMS 111. This data can be accessed and reused by the vehicle control ECU 300 as needed. The storage 360 may include, for example, a hard disk drive (HDD) or other non-volatile memory devices.

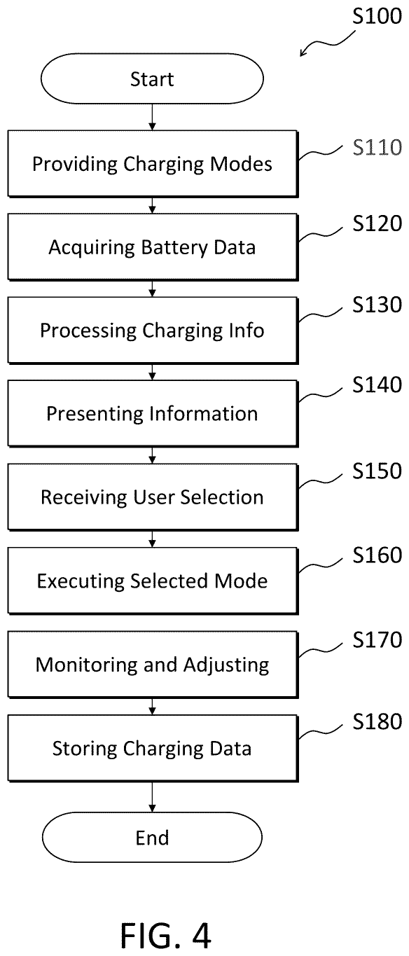

FIG. 4 is a flowchart illustrating an example process for charging a battery for a vehicle according to an embodiment. The steps of the process are executed by a computer system within the vehicle, which may include a vehicle control ECU, a battery management system (BMS), or other computing units operating collaboratively.

### Step S110: Providing Charging Modes

In step S110, the computer system provides a plurality of charging modes for charging a battery. This step may be triggered by one or more events, including but not limited to:
(a) detecting that the vehicle is connected to a charging station via a charging interface;
(b) receiving a user input via an interface, such as an infotainment system, to initiate the charging process;
(c) determining that the state of charge (SOC) or state of health (SOH) of the battery is below a predefined threshold;
(d) initiating charging based on a predefined schedule set by the user or the system;
(e) receiving a remote command from an external device, such as a mobile application or cloud-based system;
(f) detecting ambient conditions favorable for charging; or
(g) completing a prior system task, such as battery diagnostics or pre-conditioning.

Once triggered, the computer system retrieves the available charging modes, including a normal charging mode with a first charging time and an ultra-fast charging mode with a second charging time shorter than the first charging time by temporarily raising the temperature limit of the battery.

### Step S120: Acquiring Battery Data

In step S120, the computer system acquires state of health (SOH) and state of charge (SOC) data of the battery. This data is obtained from the battery management system (BMS) and may include parameters such as battery capacity, internal resistance, and temperature.

### Step S130: Processing Charging Information

In step S130, the computer system processes the acquired SOH and SOC data to generate charging information. This information includes the estimated charging times for each mode and the potential impacts on the state of health of the battery.

### Step S140: Presenting Information to the User

In step S140, the computer system provides the processed charging information to the user via an infotainment system or another user interface. The information may be displayed visually on a screen or delivered audibly through voice notifications.

### Step S150: Receiving User Selection

In step S150, the computer system receives the user's selection of a charging mode. The user selects the charging mode based on the provided information and their preferences.

### Step S160: Executing the Selected Charging Mode

In step S160, the computer system initiates and controls the charging process in the selected charging mode. This includes coordinating with the charging system to adjust charging parameters such as voltage and current based on the selected mode and the condition of the battery.

### Step S170: Monitoring and Adjusting Charging

In step S170, the computer system monitors the charging process in real-time and adjusts charging parameters as necessary to ensure safety and optimize efficiency. For example, the system may terminate the ultra-fast charging mode if the battery temperature exceeds a predetermined threshold.

### Step S180: Storing Charging Data

In step S180, the computer system stores charging-related data, including the selected charging mode, charging times, and battery status before and after charging. This data may be stored in a storage medium within the vehicle or transmitted to an external storage system for future analysis.

### EXAMPLE

The following example presents a typical user interaction with the battery charging system, highlighting the software's role in providing information and optimizing the charging process for the user's needs.

### 1. Preparation for Charging

The driver plugs the charging cable into the vehicle. Upon connection, the system automatically displays the charging menu. Alternatively, the driver may manually open the charging menu, which is accessible at all times.

The system then automatically senses the surrounding environment and gathers battery information, including:
vehicle data such as SOC, SOH, battery temperature, and maximum permissible C-rate; charging equipment data such as data from electric vehicle supply equipment maximum power capacity, current station load, and remaining available power output at the station; and
environmental data such as ambient temperature, and predicted future climate conditions.

### 2. Information Provision

The system processes the collected data and presents the following information to the driver on the vehicle's display.

### 2-1. Estimated Charging Trajectories

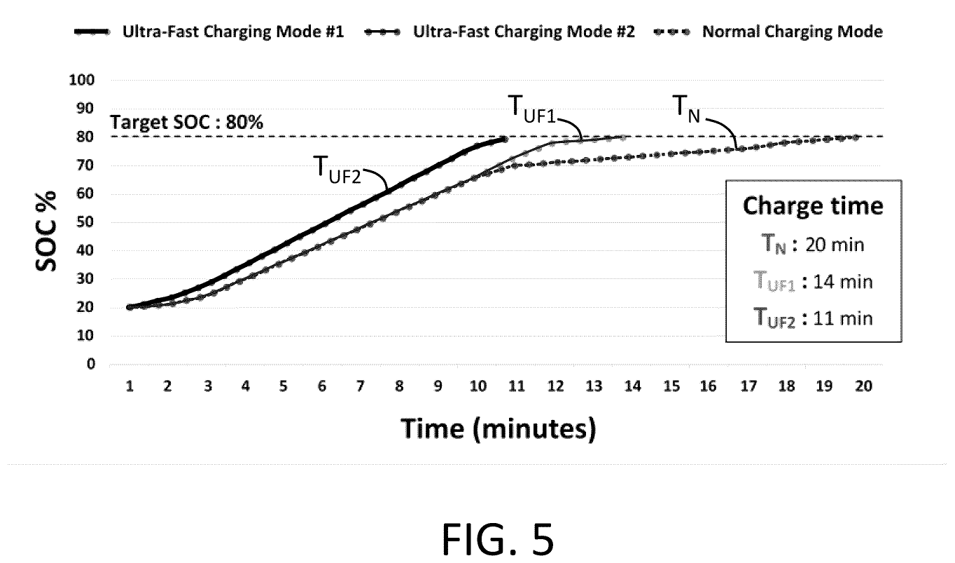

As depicted in FIG. 5, the system visualizes the estimated charging time for each charging mode (“Normal”, “Ultra-Fast Charging 1”, and “Ultra-Fast Charging 2”), showing how the current changes over time. The estimated charging time for each mode is displayed numerically (T_{N}: 20 min, T_{UF1}: 14 min, T_{UF2}: 11 min) along with a graph illustrating the charging current over time.

The graph clearly shows that both ultra-fast charging modes reach the target SOC (80%) faster than the normal charging mode, with Ultra-Fast Charging 2 being the fastest.

Providing multiple ultra-fast charging trajectories allows the driver to select the charging speed that best suits their needs. These charging modes are described in further detail in Section 6.

### 2-2. Visualization of Battery Health

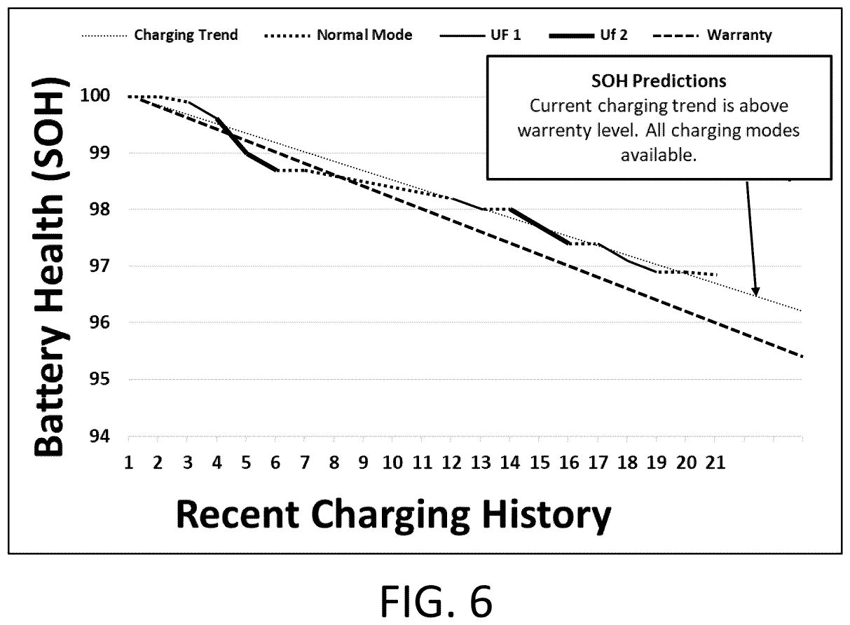

As depicted in FIG. 6, the system visualizes the historical and projected impact of each charging mode on battery health (SOH), allowing the driver to understand how their past charging behavior has affected the battery and to project how different charging choices might affect its future health.

The graph in FIG. 6 displays the SOH degradation over a period of time, possibly representing charge cycles or months. The vertical axis represents the Battery Health (SOH), with 100% indicating a new battery and lower values indicating degradation. The graph shows the historical SOH change over multiple charging sessions of different charging modes:
The dotted line (“Normal Mode”) shows the SOH change when using only normal charging, demonstrating the slowest degradation and least burden on the battery.
The thin solid line (“UF 1”) shows the SOH change when occasionally using Ultra-Fast Charging 1, with a slightly faster degradation compared to Normal Mode charging.
The thick solid line (“UF 2”) shows the SOH change when frequently using Ultra-Fast Charging 2, illustrating the most rapid degradation and highest burden on the battery.

FIG. 6 also displays the “Warranty” line (broken line) indicating the minimum SOH value within the warranty period. The “Charging Trend” line (the uppermost dotted line in FIG. 6) represents the predicted SOH change based on the driver's past charging history. By visualizing these trends, the driver can clearly see their current SOH level and understand how their charging habits have influenced the battery's health. In this case, the driver's charging habits have resulted in a healthier battery than expected, allowing the driver to confidently choose any charging mode.

### 2-3. Optional Recommendations

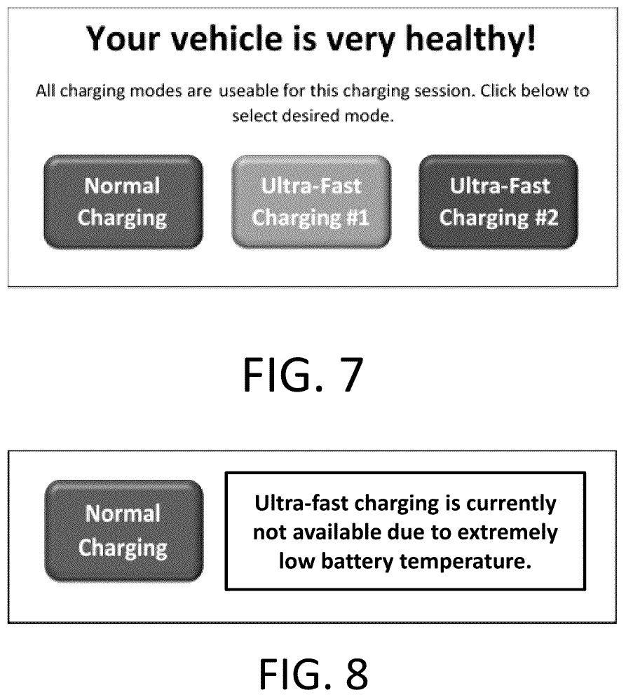

In addition to the charging trajectories and battery health information, the system may also provide an optional recommendation to the driver, suggesting a charging mode based on various factors. This recommendation, as illustrated in FIGS. 7 to 9, can be presented as an icon or a pop-up notification on the vehicle's display.

For example, FIG. 7 shows a scenario where the system has determined that the vehicle's battery is very healthy. In this case, all charging modes are available, and the system presents the driver with the option to select their desired mode. This provides flexibility for the driver to choose the charging speed that best suits their needs at that time.

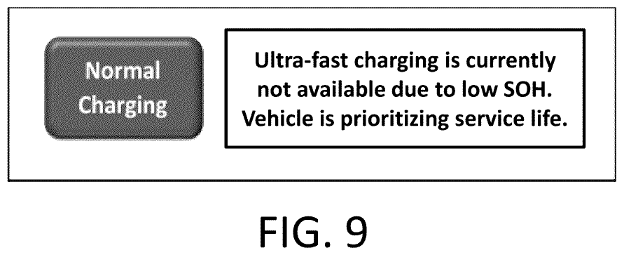

However, there may be situations where certain charging modes are not available due to factors such as low battery temperature (FIG. 8) or low SOH (FIG. 9). In these cases, the system will inform the driver of the reason for the restriction and limit the available charging options accordingly. This ensures that the driver does not inadvertently choose a charging mode that could potentially harm the battery or shorten its lifespan.

The system considers factors such as the driver's preferred charging time, the battery's current SOH, the ambient temperature, and potentially even the driver's schedule or planned route to determine the most suitable charging mode. This feature assists the driver in making informed decisions about their charging strategy, balancing charging speed with battery health considerations.

### 3. Health Check and Mode Selection

The system allows the driver to review the information provided-the estimated charging trajectories, the visualization of battery health, and any optional recommendations- and assess how each charging mode will affect their battery's health. This empowers the driver to make an informed decision about their charging strategy, considering factors such as time constraints, battery health concerns, long-term battery health, and environmental factors. By presenting this information in a clear and accessible manner, the system enables the driver to actively participate in managing their battery's health and make choices that align with their individual needs and priorities.

In this example, the driver reviews the information provided and decides to prioritize charging speed, selecting “Ultra-Fast Charging 2” for this particular session. This decision is supported by the information provided in FIG. 6, which shows that the battery is currently healthier than expected based on the driver's past charging habits.

### 4. Initiating and Managing Ultra-Fast Charging 2

Once the driver selects “Ultra-Fast Charging 2,” the system configures the charging parameters and limits accordingly. This includes raising the acceptable battery temperature limit and adjusting the charging current to maximize charging speed while staying within the safe operating limits of the battery.

Throughout the charging session, the system continuously monitors the battery's state, including its temperature, voltage, and current. If the battery temperature approaches the defined limit, the system dynamically adjusts the charging current to prevent overheating. Similarly, the system monitors the charging progress and automatically terminates the charging session once the target SOC is reached.

### 5. Completing the Charging Session

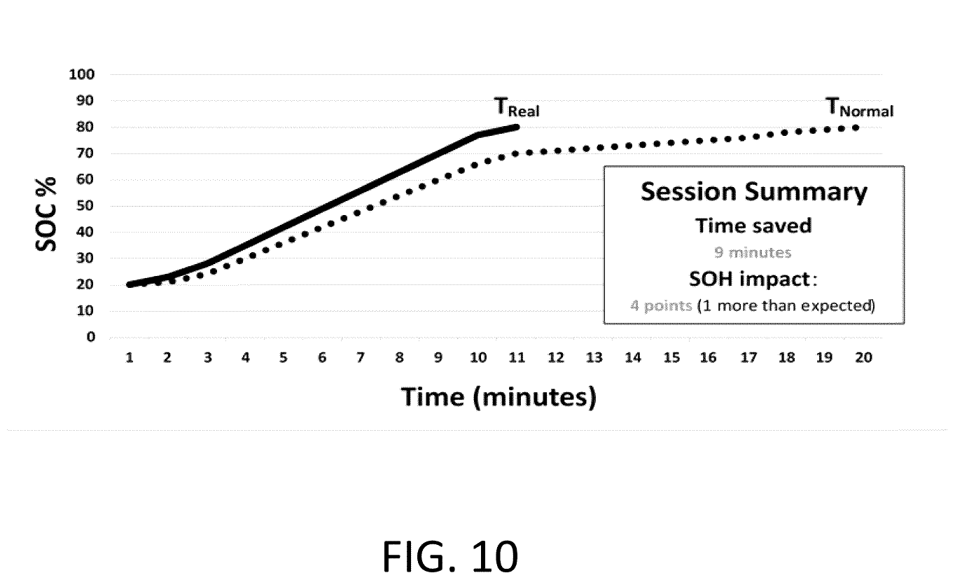

Upon completion of the charging session, the system provides a summary of the charging results to the driver, as illustrated in FIG. 10. This summary may include information such as the total charging time (T_{Real}), the amount of energy delivered to the battery, and the impact on the battery's SOH. In this example, the charging session took approximately 11 minutes (T_{Real}) to reach the desired SOC of 80%.

For comparison, the system also displays the estimated charging time (T_{Normal}) if the user had used the normal charging mode, which in this case is 20 minutes. The “Session Summary” highlights the time saved (9 minutes) by using the ultra-fast charging mode. This visualization clearly demonstrates the benefit of ultra-fast charging in reducing the overall charging time.

The system also records the charging session data, adding the data to the historical charging data used to generate future battery health visualizations and recommendations. Finally, the system resets the charging parameters to their default values to ensure that the next charging session starts with the standard safety and battery health protocols.

### 6. Charging Modes

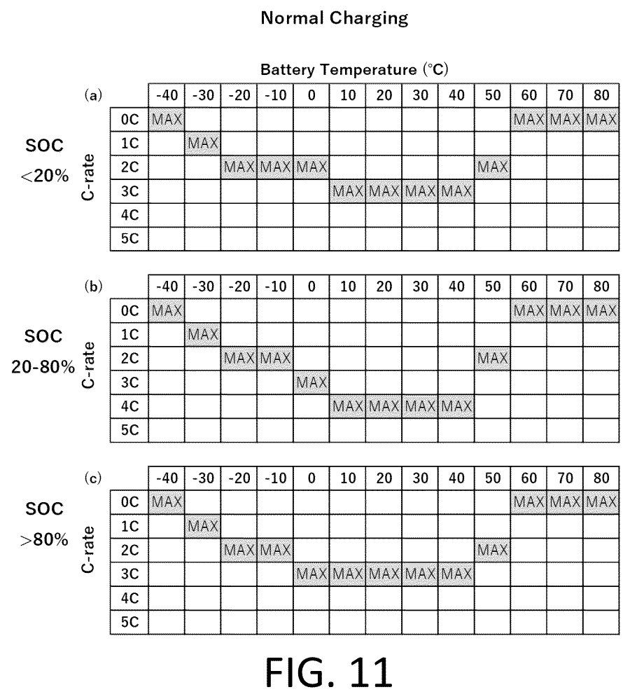

This section provides a more detailed description of the charging modes available to the driver, including how the system manages battery temperature and C-rate to balance charging speed and battery health. FIGS. 11 to 13 show tables summarizing the Normal and Ultra-Fast Charging modes, highlighting the differences in their control strategies, respectively.

To account for the varying characteristics of the battery at different charge levels, FIGS. 11 to 13 are divided into three sections: (a) SOC<20%, (b) SOC 20-80%, and (c) SOC>80%, each with its own table showing the allowable C-rates. In each table, the horizontal axis represents the battery temperature, while the vertical axis represents the C-rate, which is a measure of the charging current relative to the battery capacity. The cells indicated by “MAX” in the table indicate the allowable C-rates for different combinations of battery temperature and SOC.

### 6-1 Normal Charging

This mode prioritizes battery health by charging at a lower current and maintaining a lower maximum battery temperature. As shown in FIG. 11, which illustrates the relationship between battery temperature, State of Charge (SOC), and C-rate for Normal Charging, the maximum allowable battery temperature is 50° C. This mode minimizes stress on the battery, resulting in the slowest rate of SOH degradation.

In FIG. 11, the vertical axis represents the battery temperature, while the horizontal axis represents the C-rate, which is a measure of the charging current relative to the battery capacity. The gray cells indicated by “MAX” in the table indicate the allowable C-rates for different combinations of battery temperature and SOC. This mode minimizes stress on the battery, resulting in the slowest rate of SOH degradation.

### 6-2 Ultra-Fast Charging 1

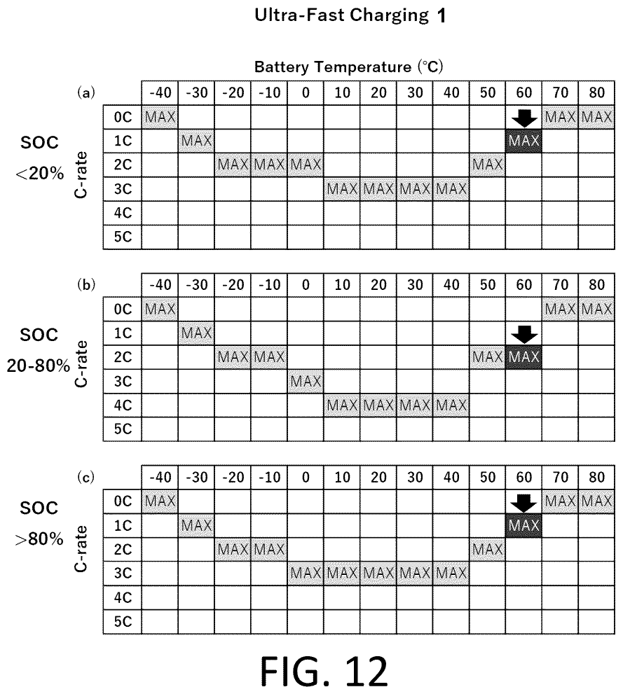

This mode offers a faster charging speed compared to normal charging by utilizing a higher charging current and increasing the maximum battery temperature limit. As depicted in FIG. 12, the maximum allowable battery temperature is increased to 60° C. This allows for a higher charging current for a longer duration while still maintaining a safe temperature threshold.

### 6-3 Ultra-Fast Charging 2

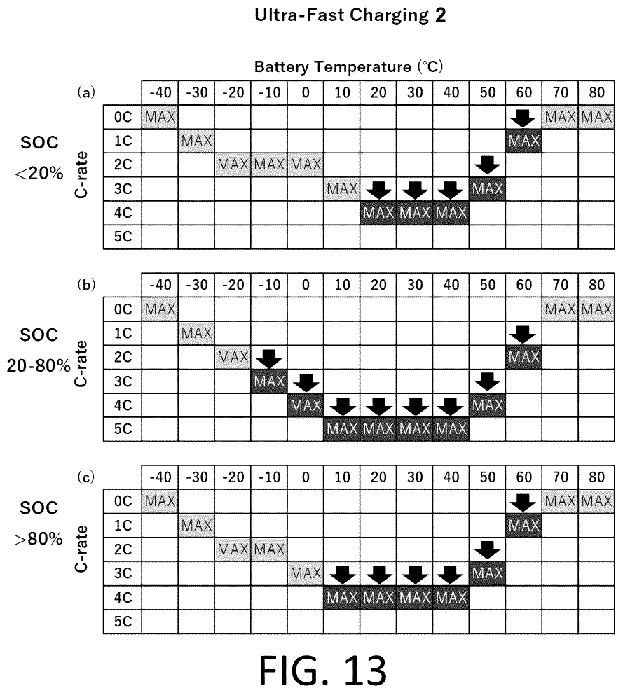

This mode, referred to as “Ultra-Fast Charging 2,” offers a sophisticated approach to ultra-fast charging by dynamically adjusting both the temperature limit and the C-rate limits based on the battery's SOC. FIG. 13 illustrates the key features of this mode.

Firstly, like the Ultra-Fast Charging 1 (FIG. 12), Ultra-Fast Charging 2 employs a variable maximum temperature limit depending on the SOC range. The maximum temperature limit is increased to 60° C. for all SOC ranges in this mode.

Secondly, Ultra-Fast Charging 2 implements tailored C-rate limits for each SOC range, as shown in FIG. 13. This refined control strategy permits higher C-rates at lower temperatures for lower SOCs and enforces more conservative C-rate limitations at higher temperatures for higher SOCs. This approach further optimizes the charging process by considering the specific characteristics of the battery at different SOC levels.

By employing these dynamic control strategies, Ultra-Fast Charging 2 achieves the fastest charging speed while mitigating potential risks to battery health. This mode is ideal for situations where minimizing charging time is crucial, but it also demonstrates the system's ability to intelligently manage battery charging to ensure both performance and longevity.

### 7. Additional Information

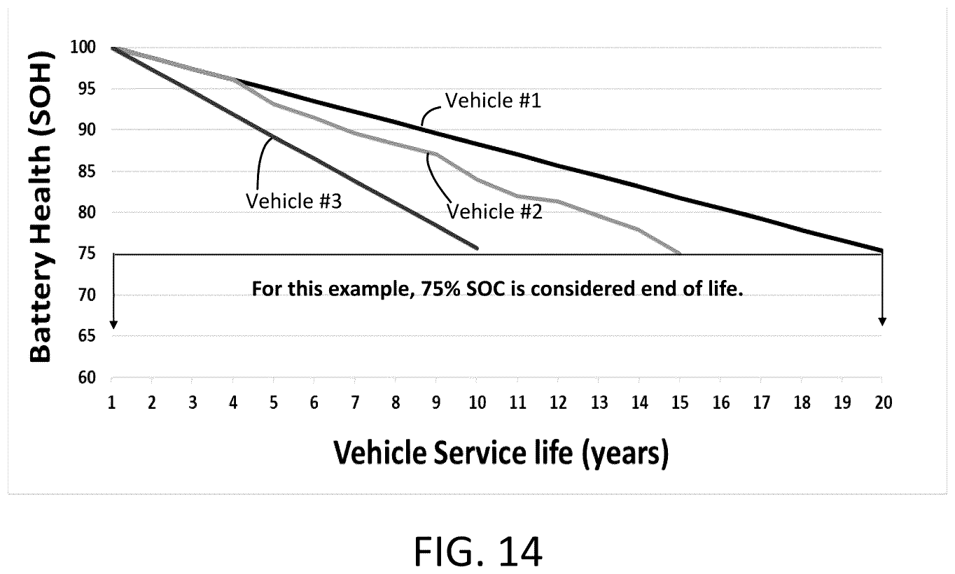

FIG. 14 shows the SOH decrease for three vehicles with different charging habits:
Vehicle #1 uses only normal charging,
Vehicle #2 occasionally uses ultra-fast charging, and
Vehicle #3 exclusively uses ultra-fast charging.

As shown in FIG. 14, frequent use of ultra-fast charging results in a significant decrease in SOH, while occasional use leads to acceptable degradation. This information further emphasizes the importance of providing users with choices and flexibility in their charging strategy. By selecting the appropriate charging mode based on their needs and the battery's condition, drivers can optimize the balance between charging speed and battery longevity.

The present disclosure also provides the following embodiments:

A001. A battery charging system for a vehicle, configured to:
(a) operate a charging of a battery in a plurality of charging modes including:
   a normal charging mode with a first charging time,
   an ultra-fast charging mode with a second charging time shorter than the first charging time by temporarily raising a temperature limit of the battery; and
(b) provide to a user an information including the charging times and impacts thereof on a state of health (SOH) of the battery for the plurality of charging modes, to assist the user to select one of the charging modes based on the provided information.

A002. The battery charging system for a vehicle according to A001 or any other embodiment, further configured to:
(c) acquire the charging mode selected by the user, and
(d) start to operate the charging of the battery in the charging mode selected by the user.

A011. The battery charging system for a vehicle according to A001 or any other embodiment,
wherein the state of the health of the battery includes a battery lifetime.

A021. The battery charging system for a vehicle according to A001 or any other embodiment, further configured to:
(f) check whether there is a condition in which any one of the plurality of charging modes should be avoided, and
(g) include a suggestion that the charging mode is to be avoided in the information to be provided to the user, or exclude the charging mode to be avoided in the information to be provided to the user.

A022. The battery charging system for a vehicle according to A021 or any other embodiment,
wherein the condition is related to an ambient temperature.

A023. The battery charging system for a vehicle according to A022 or any other embodiment,
step (f) is to check whether the ambient temperature is lower than a predetermined value for any one of the plurality of charging modes which should be avoided.

A025. The battery charging system for a vehicle according to A021 or any other embodiment,
wherein the condition is related to a charging equipment which can be coupled to the battery of the vehicle for the charging thereof.

A026. The battery charging system for a vehicle according to A025 or any other embodiment,
step (f) is to check whether the charging equipment has an option to allow the ultra-fast charging mode.

A031. The battery charging system for a vehicle, according to A001 or any other embodiment,
wherein the information is provided to the user as a visualized information or as an audible information.

A032. The battery charging system according to A031 or any other embodiment,
wherein the visualized or audible information is provided to the user via an equipment installed in the vehicle and/or via a mobile device connected to the vehicle.

A041. The battery charging system for a vehicle according to A001 or any other embodiment,
wherein the plurality of charging modes include a second ultra-fast charging mode with a third charging time shorter than the first charging time and different from the second charging time.

A051. The battery charging system for a vehicle according to A001 or any other embodiment,
wherein the impact of each mode on the SOH is represented by a point or a number corresponding to a degree of the impact on the SOH.

A061. The battery charging system for a vehicle according to A001 or any other embodiment, further configured to:
(h) acquire the SOH of the vehicle over time, and
(i) provide the acquired SOH and an expected SOH over time versus a vehicle service life.

B001. A method for charging a battery for a vehicle, comprising:
(a) providing a plurality of charging modes for operating a charging of a battery, the plurality of charging modes including:
   a normal charging mode with a first charging time,
   an ultra-fast charging mode with a second charging time shorter than the first charging time by temporarily raising a temperature limit of the battery; and
(b) providing to a user an information including the charging times and impacts thereof on a state of the health of the battery for the plurality of charging modes, to assist the user to select one of the charging modes based on the provided information.

B002. The method according to B001 or any other embodiment, further comprising:
(c) acquiring the charging mode selected by the user, and
(d) starting to operate the charging of the battery in the charging mode selected by the user.

B011. The method according to B001 or any other embodiment,
wherein the state of the health of the battery includes a battery lifetime.

B021. The method according to B001, further comprising:
(f) checking whether there is a condition in which any one of the plurality of charging modes should be avoided, and
(g) including a suggestion that the charging mode is to be avoided in the information to be provided to the user, or exclude the charging mode to be avoided in the information to be provided to the user.

B022. The method according to B021 or any other embodiment,
wherein the condition is related to an ambient temperature.

B023. The method according to B022 or any other embodiment,
step (f) is checking whether the ambient temperature is lower than a predetermined value for any one of the plurality of charging modes should be avoided.

B031. The method according to any one of B001 or any other embodiment,
wherein the information is provided to the user as a visualized information or as an audible information.

B032. The method according to B031 or any other embodiment,
wherein the visualized or audible information is provided to the user via an equipment installed in the vehicle and/or a mobile device connected to the vehicle.

B041. The method according to B001 or any other embodiment,
wherein the plurality of charging modes includes a second ultra-fast charging mode with a third charging time shorter than the first charging time and different from the second charging time.

B051. The method according to B001 or any other embodiment,
wherein the impact of each mode on the SOH is represented by a point/number corresponding to a degree of the impact on the SOH.

B061. The method according to B001 or any other embodiment, further comprising:
(h) acquiring the SOH of the vehicle over time, and
(i) providing the acquired SOH and an expected SOH over time versus a vehicle service life.

C001. A vehicle comprising the battery charging system according to any one of A001 to A061.

C002. The vehicle according to C001 or any other embodiment, the vehicle being an EV.

D001. A non-transitory computer readable storage medium comprising program codes for charging a battery for a vehicle, the program codes that, when executed by a processor, cause the processor to perform the method according to any one of A001 to A061.

The terms and expressions such as “<”, “>”, “greater than”, “less than”, “higher”, and “lower” used in this specification should not be interpreted as limiting. These expressions are used to avoid repetitive phrases such as “including equivalence” for simplicity, and they may encompass such meanings.

The terms and phrases used in this application, particularly those in the appended claims, should be construed as open-ended unless explicitly stated otherwise. For example, the term “including” should be understood as “including without limitation” or “including but not limited to.” The term “comprising,” as used herein, is synonymous with “including,” “containing,” or “characterized by” and is inclusive or open-ended, not excluding additional, unrecited elements or method steps. The term “having” should be interpreted as “having at least.” The term “including” should be interpreted as “including but not limited to.” The term “example” is used to provide illustrative examples of the item in discussion and is not a comprehensive or restrictive list.

Groups of items connected by the conjunction “and” should not be interpreted as requiring the presence of all items in the group unless explicitly stated otherwise, and should be understood as “and/or.” Similarly, groups of items connected by the conjunction “or” should not be interpreted as requiring mutual exclusivity within the group unless explicitly stated otherwise, and should be understood as “and/or.”

Regarding the use of substantially any plural or singular term in this specification in English, those skilled in the art will understand plural and singular forms as appropriate based on the context and usage. For clarity, various singular and plural permutations may be explicitly stated in this specification. The indefinite articles “a” or “an” do not exclude the presence of multiples.

Any embodiment or aspect disclosed in this specification may be combined in part or in whole with other embodiments described herein. For example, one, two, or three or more embodiments may be combined in part or in entirety. Furthermore, any feature of any embodiment or aspect disclosed herein may be applicable to or optional for other embodiments or aspects.

While preferred embodiments of the invention have been illustrated and described in this specification, it will be apparent to those skilled in the art that such embodiments are provided by way of example only. It is not intended that the invention be limited to the specific examples described herein. Although the invention has been described with reference to the foregoing specification, the description and drawings of the embodiments and examples herein are not intended to be interpreted in a limiting sense. Numerous variations, modifications, and alternatives can be devised by those skilled in the art without departing from the concept of the invention. Furthermore, it should be understood that no aspect of the invention is limited to the specific illustrations, configurations, or relative proportions described herein, which depend upon various conditions and variables. It should also be understood that various alternatives of the embodiments of the invention described herein can be used in the practice of the invention. Accordingly, the invention is to be understood as encompassing such alternatives, modifications, changes, and equivalents. The following claims define the scope of the invention, and methods and structures within the scope of these claims, and their equivalents, are intended to be encompassed therein.

1. A battery charging system for a vehicle, configured to:
(a) operate a charging of a battery in a plurality of charging modes including:
a normal charging mode with a first charging time,
an ultra-fast charging mode with a second charging time shorter than the first charging time by temporarily raising a temperature limit of the battery; and
(b) provide to a user an information including the charging times and impacts thereof on a state of health (SOH) of the battery for the plurality of charging modes, to assist the user to select one of the charging modes based on the provided information.

2. The battery charging system for a vehicle according to claim 1, further configured to:
(c) acquire the charging mode selected by the user, and
(d) start to operate the charging of the battery in the charging mode selected by the user.

3. The battery charging system for a vehicle according to claim 1, wherein the state of the health of the battery includes a battery lifetime.

4. The battery charging system for a vehicle according to claim 1, further configured to:
(f) check whether there is a condition in which any one of the plurality of charging modes should be avoided, and
(g) include a suggestion that the charging mode is to be avoided in the information to be provided to the user, or exclude the charging mode to be avoided in the information to be provided to the user.

5. The battery charging system for a vehicle according to claim 4, wherein the condition is related to an ambient temperature.

6. (canceled)

7. The battery charging system for a vehicle according to claim 4, wherein the condition is related to a charging equipment which can be coupled to the battery of the vehicle for the charging thereof.

8. The battery charging system for a vehicle according to claim 7, step (f) is to check whether the charging equipment has an option to allow the ultra-fast charging mode.

9. The battery charging system for a vehicle, according to claim 1, wherein the information is provided to the user as a visualized information or as an audible information.

10. The battery charging system according to claim 9, wherein the visualized or audible information is provided to the user via an equipment installed in the vehicle and/or via a mobile device connected to the vehicle.

11. The battery charging system for a vehicle according to claim 1, wherein the plurality of charging mode includes a second ultra-fast charging mode with a third charging time shorter than the first charging time and different from the second charging time.

12. The battery charging system for a vehicle according to claim 1, wherein the impact of each mode on the SOH is represented by a point/number corresponding to a degree of the impact on the SOH.

13. The battery charging system for a vehicle according to claim 1, further configured to:
(h) acquire the SOH of the vehicle over time, and
(i) provide the acquired SOH and an expected SOH over time versus a vehicle service life.

14. A vehicle comprising the battery charging system according to claim 1.

15. (canceled)
